(19) United States
(12) Patent Application Publication
(10) Pub. No.: US 2023/0395941 A1
(43) Pub. Date: Dec. 7, 2023

(54) SEPARATOR PLATE COMPRISING AN ALTERNATING EDGE IN THE PORT REGION

(71) Applicant: Reinz-Dichtungs-GmbH, Neu-Ulm (DE)

(72) Inventors: Andre SPEIDEL, Neu-Ulm (DE); Bernd GAUGLER, Neu-Ulm (DE)

(21) Appl. No.: 18/328,602

(22) Filed: Jun. 2, 2023

(30) Foreign Application Priority Data
Jun. 2, 2022 (DE) 20 2022 103 145.2

(51) Int. Cl. H01M 50/463

(52) U.S. Cl. CPC H01M 50/463

(57) ABSTRACT

A separator plate for an electrochemical system, a bipolar plate comprising two such separator plates, an electrochemical cell, and an electrochemical system comprising a multiplicity of such separator plates or bipolar plates are disclosed. By way of example, the electrochemical system may be a fuel cell system, an electrochemical compressor, a redox flow battery or an electrolyzer. The separator plate for an electrochemical system, comprising at least one through-opening and at least one bead arrangement. An edge portion stretches between the at least one bead arrangement and a border of the at least one bead arrangement. The edge portion has recesses and projections starting from the border and alternating successively along a border contour in some portions, wherein the recesses project downwards out of the plate plane and the projections project upwards out of the plate plane.

### CROSS-REFERENCE TO RELATED APPLICATION

The present application claims priority to German Utility Model Application No. 20 2022 103 145.2, entitled “SEPARATOR PLATE COMPRISING AN ALTERNATING EDGE IN THE PORT REGION”, and filed on Jun. 2, 2022. The entire contents of the above-listed application is hereby incorporated by reference for all purposes.

### TECHNICAL FIELD

The present disclosure relates to a separator plate for an electrochemical system, to a bipolar plate comprising two such separator plates, to an electrochemical cell, and to an electrochemical system comprising a multiplicity of such separator plates or bipolar plates. By way of example, the electrochemical system may be a fuel cell system, an electrochemical compressor, a redox flow battery or an electrolyzer.

### BACKGROUND AND SUMMARY

Known electrochemical systems normally have a stack of electrochemical cells, one half of a bipolar plate forming said cells in each direction of the stack extension, the bipolar plate terminating the cells towards the exterior. Bipolar plates of this kind can, for example, be used for indirectly electrically contacting the electrodes of the individual electrochemical cells (e.g. fuel cells) and/or for electrically connecting adjacent cells (serially connected cells). The bipolar plates are typically formed of two individual separator plates which are joined together. The separator plates of the bipolar plate may be integrally bonded together, for example using one or more welds, such as using one or more laser welds.

The bipolar plates or separator plates can each have or form structures that are configured, for example, for supplying one or more media to the electrochemical cells terminated by adjacent bipolar plates and/or for carrying reaction products away therefrom. The media may be fuels (e.g. hydrogen or methanol) or reaction gases (e.g. air or oxygen). Furthermore, the bipolar plates and/or the separator plates may have structures for guiding a cooling medium through the bipolar plate, such as through a cavity enclosed by the separator plates of the bipolar plate. Furthermore, the bipolar plates may be designed to transmit the waste heat that arises when converting electrical and/or chemical energy in the electrochemical cell, and also to seal off the various media channels and cooling channels with respect to one another and/or with respect to the outside.

Moreover, the bipolar plates or separator plates usually each have at least one or more through-openings. Through the through-openings, the media and/or the reaction products may be led to the electrochemical cells terminated by adjacent bipolar plates of the stack or into the cavity formed by the separator plates of the bipolar plate, or may be led out of the cells or cavity. Generally, the through-openings are arranged in alignment with one another and form fluid conduits extending in the stacking direction, e.g. perpendicularly to the respective plate planes of the separator plates or bipolar plates.

The electrochemical cells typically also each comprise one or more membrane electrode assemblies (MEAs). The MEAs may have one or more gas diffusion layers, which are usually oriented towards the bipolar plates and are designed for example as a metal or carbon fleece.

The seal between the bipolar plates and the membrane electrode assembly is usually provided outside the electrochemically active region and usually comprises both at least one port seal, arranged around the through-opening, and an external seal, both of which may be formed as bead arrangements. Often, however, at least the port seals, but in some cases the external seal too (also referred to as a peripheral seal), are intended for allowing media to locally pass from the through-opening to/from the electrochemically active region in a targeted manner. For this purpose, bead arrangements may comprise passages, which may be configured either as openings or as elevations of the flanks thereof.

Making the surface area of the electrochemically active region of the separator plate or bipolar plate as large as possible generally increases efficiency of the electrochemical system and keeps the proportion of the surface area of other structures, such as the through-openings, as small as possible. For example, instead of circular through-openings, through-openings of different shape, such as polygonal, such as rectangular through-openings, may be provided in order to make the most efficient use of the surface area of the separator plate. In that case, the associated port seal running around the through-opening usually has a corresponding polygonal or rectangular shape.

Usually, bead arrangements have a bead top, two bead sides or bead flanks, each adjacent to said bead top, and bead bottoms. In this case, the top may have a flat portion or be predominantly domed in cross section. Generally, different contour shapes of the bead arrangement, for example straight or curved portions, lead to different bead stiffnesses in portions having a different contour shape. Furthermore, a bead stiffness of a bead arrangement may not be constant in a main extension direction of the bead arrangement, owing to a shape and contour of adjacent elements, for example an edge adjoining the bead arrangement or even a bead arrangement adjoining said bead arrangement in some portions or extending adjacent thereto. Due to the aforementioned influencing factors, the elasticity of the bead arrangements may locally increase or decrease, which in turn may have an adverse effect on the actual compression of each bead arrangement in their various portions. The risk here is that media inadvertently flow through the bead arrangement in regions of lesser compression, or that operating media flow into the interior of the bipolar plate and that coolants reach the exterior of the bipolar plate. In this case, the relevant media for operating the electrochemical system are lost and may potentially trigger uncontrolled reactions that may damage the system. Moreover, there is the risk that coolant reaches the region of the operating media, where it damages the MEA, for example.

Owing to the large number of bipolar plates or individual plates in a stack, a minor difference in the compression and resilience of the bead arrangement along its contour in just one bipolar plate or in just one separator plate can lead to a relatively large difference in the resilience of the serially connected bead arrangements, so slight differences in the individual separator plates have a significant impact on the tightness of the stack as a whole.

Against this background, one of the problems addressed by the present disclosure is to create a separator plate or bipolar plate for an electrochemical system that improves tightness and/or efficiency of the electrochemical system. In addition, an electrochemical cell and an electrochemical system having a multiplicity of stacked bipolar plates or cells will be disclosed.

This problem is solved by the separator plate, the bipolar plate, the electrochemical cell and the electrochemical system according to the independent claims. Developments are the subject of the dependent claims and a component of the following description.

According to one aspect of the present disclosure, a separator plate for an electrochemical system is proposed. The separator plate has at least one through-opening, having a border delimiting the through-opening, for the passage of a fluid. In addition, the separator plate has at least one bead arrangement, such as a port bead, which extends around the through-opening at a distance from the border at least in some portions and projects upwards out of a plate plane defined by the separator plate. An edge portion stretches between the at least one bead arrangement and the border. The edge portion has recesses and projections starting from the border and alternating successively in some portions along a border contour. In the process, each recess projects out of the plate plane in the opposite direction to the at least one bead arrangement, e.g. downwards when the bead top is assumed to be pointing upwards, and each projection projects out of the plate plane in the same direction as the at least one bead arrangement, e.g. upwards when the bead top is assumed to be pointing upwards.

According to a further aspect of the present disclosure, a separator plate for an electrochemical system has at least one through-opening for the passage of a fluid, and a border delimiting the through-opening. In this case, the border has a curved portion in a corner region of the through-opening. In addition, the separator plate has at least one bead arrangement, for example a port bead or a peripheral bead, which extends around the through-opening at a distance from the border at least in some portions and projects upwards out of a plate plane defined by the separator plate. The separator plate has at least one strain-relief bead, spaced apart from the at least one bead arrangement, for relieving the strain on the at least one bead arrangement when the separator plate is in a compressed state. The strain-relief bead adjoins the curved portion of the border or is arranged outside an edge portion stretching between the at least one bead arrangement, such as the port bead, and the curved portion of the border such that the at least one bead arrangement extends between the strain-relief bead and the curved edge portion.

The strain-relief bead may project upwards out of the plate plane. The strain-relief bead may be arranged within a surface area encompassed by the at least one bead arrangement, for example by the port bead, where it may adjoin the curved portion of the border or start from the border, or it may be arranged outside a surface area encompassed by the bead arrangement, such as by the port bead, or, for example, be arranged outside a surface area traversed by the peripheral bead, such that the at least one bead arrangement extends between the strain-relief bead and the border. To allow the strain-relief bead to make an active contribution to relieving the strain on the at least one bead arrangement, a minimum distance from the strain-relief bead to the at least one bead arrangement may generally be at most 1.2 mm, for example at most 0.8 mm. Furthermore, the minimum distance may be at least 0.5 mm, such as at least 0.2 mm.

Said projections, recesses and strain-relief beads can influence the stiffness or compliance of the separator plate in the region of the through-opening. By way of example, the projections and recesses may locally increase the stiffness of the separator plate in a direction perpendicular to the plate plane. This can prevent the edge portion from bending out of the plate plane when pressure is applied to the at least one bead arrangement. If, for example, the separator plate is installed in an electrochemical system and compressed therein with other separator plates to form a stack, the projections and recesses can prevent adjacent separator plates from diverging in the region of the through-opening (also referred to as the port region) owing to a leverage effect. This reduces the risk of a short circuit and of damage to an MEA arranged between the separator plates. Overall, by arranging the projections and recesses in an alternating manner, forces can be distributed to the at least one bead arrangement more uniformly. Independently of this, the strain-relief beads can also influence the stiffness of the separator plates in the directions spanned by the plate plane. Providing the strain-relief beads in the edge portion can prevent compressive stresses from building up therein in the material of the separator plate. Thus, a local stiffness of the at least one bead arrangement in the corner region of the through-opening can be reduced, as a result of which forces can be distributed to the at least one bead arrangement more uniformly, for instance when the separator plate is installed in an electrochemical system.

Embodiments of the projections, recesses and strain-relief beads thus help distribute forces to the at least one bead arrangement more uniformly, thereby allowing the tightness of the system or stack to be improved. In doing so, one may profit from the fact that the stiffness of the separator plate is reduced in the corner region of the through-opening and increased in straight portions of the through-opening.

The features of the first aspect (inter alia, alternating projections and recesses) and the features of the second aspect (inter alia, strain-relief beads) can be combined. On the other hand, the projections and recesses stated in relation to the above-described first aspect need not necessarily be present in the embodiments having a strain-relief bead. Moreover, the strain-relief beads according to the second aspect need not necessarily be present in embodiments having the projections and recesses according to the first aspect.

The embodiments and features described below can relate to both of the aforementioned aspects of the present disclosure unless it is obvious that only one of the two aspects is or may be meant.

The plate plane can be defined substantially by non-deformed regions of the separator plate. Non-deformed regions may refer to the regions of a separator plate that are planar and not part of a bead. These are, for example, regions without any stampings. In the following, the “height” refers to the distance from the relevant region to the plate plane, measured perpendicularly to the plate plane, where said region projects out of the plate plane on the same side as the at least one bead arrangement. The “depth” refers to the distance from the relevant region to the plate plane, measured perpendicularly to the plate plane, where the region projects out in the opposite direction. Thus, the at least one bead arrangement and the projection can be referred to as an embossing and the recess can be referred to as an imprint.

The projections and recesses can be formed as stampings defined along the border contour, having a portion that extends substantially in parallel with the plate plane and transition regions that extend in a curved or oblique manner with respect to the plate plane. The projections and recesses can thus be stampings that each extend in a distinct region of the border such that the border itself projects upwards out of the plate plane in the region of a projection and projects downwards out of the plate plane in the region of a recess. In this case, the border can have a constant contour and is, for example, not interrupted between the regions having projections or recesses and regions not having projections or recesses. Between projections and recesses and/or between projections and projections or between recesses and recesses, the border can extend substantially in the plate plane and/or in parallel with the plate plane. Often, the border has a straight contour between adjacent projections and recesses, at least in one region of the through-opening.

The projections and recesses on the one hand, and the at least one bead arrangement on the other, are usually stamped elements that are separated from one another. The projections and the recesses may be arranged at a distance from the closest bead arrangement. A minimum distance from the projections or recesses to said bead arrangement can, for example, be at least 0.2 mm and/or at most 2.5 mm. This means that one part of the edge portion extends between the projections and the closest bead arrangement or between the recesses and the closest bead arrangement. The part of the edge portion that separates the at least one bead arrangement from the projections and recesses may be planar and/or extend in the plate plane and/or in parallel with the plate plane. Adjacent projections and recesses may be at the same or varying distances from one another.

The projections and recesses each have an outline that can be defined substantially by the boundary between each projection and recess and the adjoining planar regions of the edge portion.

Since the projections and recesses start from the border, the border portion enclosed by each projection and recess also forms a part of the outline. The shape of the outlines can be structured freely. In this respect, the shape of the outline may either be the same or vary from projection to projection and/or from recess to recess. When projected onto the plate plane, the outlines may form a quadrilateral, such as a trapezium or a rectangle, or any polygon, that may have rounded corners. When projected onto the plate plane, the outlines may also be wave-like in some portions and/or may follow or extend in parallel with the contour of the bead arrangement. For instance, the shape of the outline of a projection or recess may, when projected onto the plate plane, correspond substantially to that of a rectangle of which the longitudinal direction extends in parallel with the border. The length of the rectangle may, for example, correspond to at least 1.5 times, 2 times or 2.5 times the width of the rectangle. In the process, the corners of the rectangle may be rounded. Irrespective of this, at least one portion of an outline may extend in parallel with the border. Independently of this, it may be advantageous if at least one portion of an outline starts from the border substantially perpendicularly. Irrespective of this, at least one portion of an outline of a projection and/or of a recess may be adapted to the contour of the at least one bead arrangement, such as of the port bead. By way of example, it is conceivable here for the outline to follow the contour of said bead arrangement at least in some portions. The possibility of freely structuring the outlines of the projections and recesses allows these structures to be optimally adapted to the local stiffening of the separator plate.

The at least one bead arrangement may have a wave-like contour in some portions. In some embodiments, the at least one bead arrangement may have alternating convex and concave regions at least in some portions. This means that the edge portion adjoining the at least one bead arrangement, such as the port bead, has convex and concave regions. A projection or a recess can be assigned to convex or concave regions of the at least one bead arrangement. It may also be provided that the projections and recesses are decoupled from the convex and concave regions of the at least one bead arrangement either in some portions or along the entire contour of the at least one bead arrangement. Independently of this, there may be embodiments in which unequal distances occur between adjacent projections and recesses and/or between closest projections and between closest recesses.

In addition, the border may be formed in a substantially straight manner along its contour between the projections and recesses. If at least at one point per corner region of each port, the actual curved corner region extends between one projection/recess and another projection/recess it may prove advantageous. Alternatively or additionally, the border may also be formed in a straight manner at least in some portions in the region of the projections and/or recesses. In this context, in a straight manner along the border contour means that the border does not have any curvature along its contour. In this case, the projection of the border onto the plate plane and/or the projection of the border onto a plane perpendicular to the plate plane may be straight and have no curvature.

In addition, the projections and/or the recesses may each be configured to have different lengths and widths. In this case, the length denotes the extension of the projections and recesses along the border, and the width denotes the extension of the projections and recesses perpendicular to the border. The projections may be configured to be longer and wider than the recesses in some embodiments.

Embodiments in which the projections are each formed having different heights and/or in which the recesses are each formed having different depths are also conceivable. It is also conceivable for at least one projection to be formed higher than the other raised portions and/or for at least one recess to be formed deeper than the other recesses. The projections may be higher than the recesses are deep in some embodiments. In other words, the distance from the projections to the plate plane measured perpendicularly to the plate plane is greater than the distance from the recesses to the plate plane measured perpendicularly to the plate plane. In this case, the projections can be configured to receive recesses of an adjacent separator plate; see further below.

In an embodiment, the edge portion has, at least in some portions, regions that are located in the plate plane and/or are configured as planar surfaces and/or are oriented in parallel with the plate plane and/or do not have any stampings.

Typically, the at least one bead arrangement is configured to seal a region of the separator plate, for example from the surrounding area and/or from the interior of the separator plate or bipolar plate or from the electrochemical cell, the stack or the electrochemical system. For instance, the port bead can be intended for sealing the through-opening whereas the peripheral bead can be intended for sealing another region, such as the electrochemically active region. In an exemplary embodiment, the at least one bead arrangement has a bead top, which is oriented in parallel with the plate plane and/or is configured as a planar surface. Independently of this, at least one projection may have a projection top, which is oriented in parallel with the plate plane and/or is configured as a planar surface. It is also conceivable for at least one recess to have a recess base, which is oriented in parallel with the plate plane and/or is configured as a planar surface.

Optionally, the projections and recesses may also have flanks configured as curved or planar surfaces or as substantially planar surfaces that are not oriented in parallel with the plate plane. The line on which a flank of this kind intersects the plate plane can be referred to as a flection border. In one embodiment, the projections and recesses have, on their side remote from the through-opening, a flection border which extends in parallel with the border portion that has the relevant projection or recess. Flection borders that do not extend in parallel with the border portion are also possible, as are flection borders that follow the bead contour of the at least one bead arrangement, such as of the closest bead arrangement. There may be embodiments in which the projections and recesses have both flanks and projection tops or recess bases, respectively, of the above-described type. Also possible are embodiments in which a curved portion is arranged between a flank and a projection top or a recess base, said curved portion interconnecting the two regions.

In one embodiment, the through-opening has at least one corner region. In a corner region of the through-opening, the border may have two straight portions that meet at an angle. Embodiments in which the two straight portions of the border are interconnected by means of a curved portion of the border are also possible. A curved edge portion extends between the curved portion of the border and the bead arrangement.

As already indicated above, at least one strain-relief bead can adjoin the curved portion and/or the straight portion of the border, or is arranged outside the edge portion such that the at least one bead arrangement, or where applicable both bead arrangements, e.g. the port bead and the peripheral bead for example, extend(s) between the strain-relief bead and the curved edge portion. Embodiments having more than one strain-relief bead are also possible. In addition, at least one strain-relief bead may be arranged in a straight edge portion, which is spanned by a straight portion in the corner region of the border and the bead arrangement closest thereto, such as the port bead, as long as there is no projection and/or recess arranged between said strain-relief bead and the closest curved edge portion. In a cross section transverse to their respective longitudinal directions, the strain-relief beads may be arcuate or U-shaped at least in some portions, and as such may have a certain springiness so that no undesirable forces and/or stresses build up in the material of the separator plate.

In the following, a distinction is sometimes drawn between inner strain-relief beads and outer strain-relief beads, an inner strain-relief bead being a strain-relief bead that adjoins the border and/or is arranged inside the surface area encompassed by the at least one bead arrangement, and an outer strain-relief bead being a strain-relief bead that is arranged outside the edge portion or outside the surface area encompassed by the port bead and, where applicable, traversed by a peripheral bead adjacent to said port bead, such that the at least one bead arrangement extends between the outer strain-relief bead and the border.

In terms of their cross section, inner strain-relief beads and outer strain-relief beads can both be formed as full beads having two bead sides. Inner strain-relief beads may be formed as semi-open beads, each extending in a distinct region of the border. The semi-open beads project upwards out of the plate plane. The border itself thus also projects upwards out of the plate plane in the region of an inner strain-relief bead. Outer strain-relief beads may be formed as closed beads having a region all the way around that does not extend in parallel with the plate plane.

It may be provided that at least one strain-relief bead has a cut-out, at least in one of its end regions, that connects the edge region to the raised region of the strain-relief bead. In this case, the cut-out may be spaced apart from the at least one bead arrangement. An inner strain-relief bead and an outer strain-relief bead may both be formed such as to have a cut-out in at least one of their end regions. This cut-out may connect the edge region, e.g. the region extending in the plate plane, to the raised region of the strain-relief bead. In this case, the cut-out may be spaced apart from the closest bead arrangement thereto. The cut-out can form an opening in the separator plate. Usually, the cut-out is formed as a punched part or cut-out part in the plate. For instance, an outer strain-relief bead provided with such a cut-out is arranged such that a circumferential weld seam following said bead arrangement is arranged between the cut-out and the closest bead arrangement thereto, such that the cut-out does not hamper the sealing. Instead of individual cut-outs assigned to separate strain-relief beads, cut-outs that adjoin a plurality of strain-relief beads but which, in the process, are likewise spaced apart from the closest bead arrangement are also possible.

Inner and outer strain-relief beads each have an outline that can be defined substantially by the boundary between each strain-relief bead and the adjoining planar regions of the separator plate. Since the inner strain-relief beads generally start from the border, the border portion enclosed by each inner strain-relief bead also forms a part of the outline. The shape of the outlines of the strain-relief beads can be freely structured, but the outlines may be basic shapes based on a rectangular shape or a trapezium, apart from their end regions. In this case, the shape can vary from strain-relief bead to strain-relief bead. The outline of the strain-relief bead can, for example, be a rectangle having rounded corners when projected onto the plate plane. By way of example, one side of the rectangle may also be curved and may follow the contour of the enclosed portion of the border. In this case, a length of the rectangle may correspond to at least 4 times, 3 times, 2 times or 1.5 times the width of the rectangle. The radius of the rounded corners may correspond to half the width of the rectangle. Trapezoidal shapes may fan out either towards the port or away from the port.

Independently of this, at least one portion of the outline of an inner strain-relief bead may proceed from the border in an angular manner, for instance perpendicularly. By way of example, it is also conceivable for the contour of at least one outline of a strain-relief bead to be adapted to or to follow the contour of, for example, the closest bead arrangement, at least in some portions. This may mean that, for example, the length of the strain-relief beads is different in the direction perpendicular to the border and/or is adapted to the contour of the at least one bead arrangement, such as of the closest bead arrangement.

Optionally, the at least one strain-relief bead may be arranged such that a straight line extending in a longitudinal direction of the strain-relief bead intersects the curved edge portion of the border. The straight line may extend in a longitudinal direction of the strain-relief bead intersects the curved edge portion at an angle greater than 70°, for example greater than 80° and less than 110°, for example less than 100°. In one embodiment, the at least one strain-relief bead is arranged such that a straight line extending in the longitudinal direction of the strain-relief bead intersects the curved edge portion of the border perpendicularly, e.g. at an angle of 90°.

Independently of this, the strain-relief beads may be the same height or a different height, e.g. may project out of the plate plane by the same amount or by different amounts. Likewise, all the strain-relief beads may project out of the plate plane to a lesser extent than the at least one bead arrangement. The widths and lengths of the strain-relief beads may also be the same as one another or vary from one another.

The at least one bead arrangement may be a port bead surrounding a through-opening. In the process, this bead arrangement usually extends fully around the through-opening. However, the at least one bead arrangement may also be a peripheral bead. On the side of a port bead remote from the through-opening, the peripheral bead usually wraps around said through-opening only in some portions in the close range. In an example configuration of this kind, the two bead arrangements, for example a port bead and a peripheral bead, are often located very close to one another, and in this case outer strain-relief beads may be arranged on the side of said two bead arrangements that is remote from the through-opening, also because the installation space between the two bead arrangements may in most cases be very limited. This is not intended to mean that a peripheral bead surrounds a through-opening, because when said peripheral bead extends close to the outer edge of the separator plate, it substantially surrounds a multiplicity of elements, or all the elements, of the separator plate.

In one embodiment, the at least one bead arrangement, the projections, the recesses and/or the strain-relief beads are molded into the separator plate. By way of example, the at least one bead arrangement, projections and strain-relief beads may be embossed, and the recesses may be imprinted. In this case, the at least one bead arrangement, the projections, the recesses and/or the strain-relief beads may be molded into the material of the separator plate by, for example, hydroforming, stamping and/or deep drawing. In the process, a plate body of the separator plate may be produced from a metal sheet, for example from a stainless-steel sheet or a sheet made of a titanium alloy. In this case, the plate body may also be coated at least in some portions, for example in the region of the at least one bead arrangement.

A further aspect of the present disclosure relates to a bipolar plate having two interconnected separator plates of the above-described type. In this case, the separator plates are configured and arranged with respect to one another such that the through-openings are arranged in alignment with one another or so as to partly overlap, and the bead arrangements of the separator plates point away from one another. In the process, the separator plates may be arranged such that they are in contact with each other at their edge portions at least in some portions. Optionally, the edge portions of the two separator plates may be interconnected by means of at least one weld. It is also possible for a weld, such as a tight and circumferential weld, to be arranged on the side of the at least one bead arrangement remote from the through-opening.

Optionally, projections and recesses may be formed in the two separator plates in such a way that the recesses of one separator plate engage in the projections of the other separator plate or the recesses of one separator plate are in contact with the projections of the other separator plate at least in some portions. In this case, “engage” may mean that a recess of one separator plate may be arranged at least in part in a volume that is enclosed by a projection of the other separator plate and the relevant plate plane. Generally, the strain-relief beads of the interconnected separator plates point away from one another, such as by their bead tops.

A further aspect of the present disclosure relates to an electrochemical cell having two separator plates of the above-described type. Furthermore, the electrochemical cell has a membrane electrode assembly (MEA) extending between the separator plates. The through-openings of the separator plates of the electrochemical cell are arranged in alignment with one another or so as to partly overlap, and the bead arrangements of the separator plates face one another. The projections and/or strain-relief beads of the separator plates may form support elements for the membrane electrode assembly (MEA), such as in the MEA region in which the reinforcement edge extends.

A further aspect of the present disclosure relates to an electrochemical system having a multiplicity of stacked separator plates of the above-described type and/or a multiplicity of stacked bipolar plates of the above-described type and/or a multiplicity of stacked electrochemical cells of the above-described type.

The present disclosure will be described and explained below by way of example on the basis of various figures. Like and similar elements of the separator plates and bipolar plates and arrangements are given like or similar reference signs and will therefore not always be described more than once. The following examples include the features according to the present disclosure together with one or more optional enhancements or developments according to the present disclosure. However, it is possible to use separate elements of said enhancements and developments even independently of the other elements of the examples or even in combination with specific other elements of the same example or of other examples, and to further enhance the present disclosure thereby.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a schematic perspective view of an electrochemical cell having a multiplicity of stacked separator plates and/or stacked bipolar plates and/or stacked electrochemical cells.

FIG. 2 is a schematic perspective view of a bipolar plate of the system according to FIG. 1 having a membrane electrode assembly according to the prior art arranged between the bipolar plates.

FIG. 3 is a schematic plan view of a segment of a bipolar plate according to the prior art.

FIG. 4 schematically shows, in two sub-figures FIG. 4A and 4B, a segment of a bipolar plate in the region of a through-opening according to a first embodiment of the present disclosure, in a perspective view and a detailed view, respectively.

FIG. 5 schematically shows, in four sub-figures FIG. 5A, 5B, 5C and 5D, a segment of a bipolar plate in the region of a through-opening according to the first embodiment of the present disclosure, in a plan view and three sectional views, respectively.

FIG. 6 schematically shows, in three sub-figures FIG. 6A, 6B and 6C, a segment of a bipolar plate in the region of a through-opening according to a second embodiment of the present disclosure, in a plan view and two sectional views, respectively.

FIG. 7 is a schematic plan view of a segment of the two separator plates of a bipolar plate in the region of a through-opening according to a third embodiment of the present disclosure.

FIG. 8 is a schematic plan view of a segment of a bipolar plate in the region of a through-opening according to a fourth embodiment of the present disclosure.

FIG. 9 is a schematic plan view of a segment of a bipolar plate in the region of a through-opening according to a fifth embodiment of the present disclosure.

FIG. 10 is a schematic plan view of a segment of a bipolar plate in the region of a through-opening according to a sixth embodiment of the present disclosure.

FIG. 11 is a schematic plan view of a segment of a bipolar plate in the region of a through-opening according to a seventh embodiment of the present disclosure.

### DETAILED DESCRIPTION

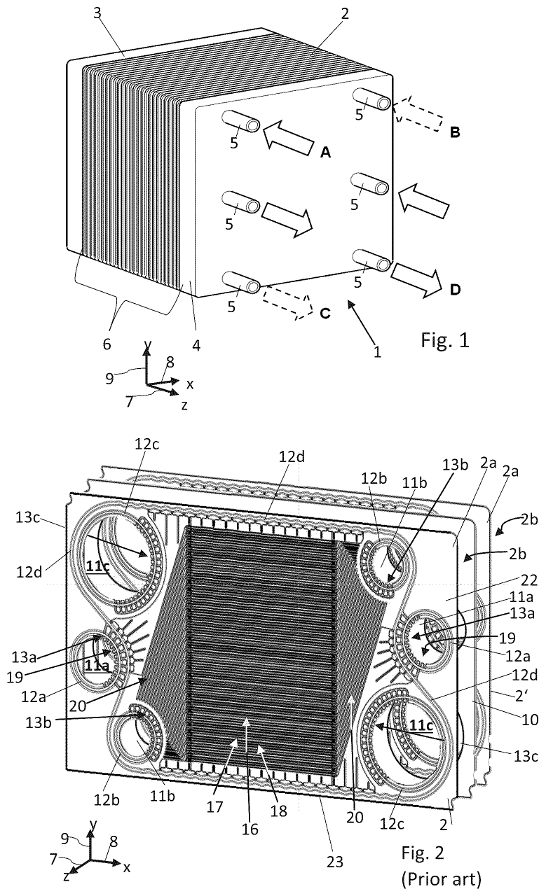

FIG. 1 shows an electrochemical system 1 having a plurality of identical metal bipolar plates 2, which are arranged in a stack 6 and stacked in a z-direction 7. The bipolar plates 2 of the stack 6 are clamped between two end plates 3, 4. The z-direction 7 will also be referred to as the stacking direction. In this example, the system 1 is a fuel cell stack. Each two adjacent bipolar plates 2 of the stack thus delimit between them an electrochemical cell, which is used, for example, to convert chemical energy into electrical energy. In each case, one of the separator plates of a bipolar plate forms the cell delimited by the bipolar plate. To form the electrochemical cells of the system 1, a membrane electrode assembly (MEA) is arranged between each adjacent bipolar plate 2 of the stack (see e.g. FIG. 2). The MEAs typically contain in each case at least one membrane, e.g. an electrolyte membrane. Furthermore, a gas diffusion layer (GDL) may be arranged on one or both surfaces of the MEA.

In alternative embodiments, the system 1 may also be configured as an electrolyzer, as an electrochemical compressor, or as a redox flow battery. Bipolar plates can likewise be used in these electrochemical systems. The structure of these bipolar plates may then correspond to the structure of the bipolar plates 2 explained in detail here, although the media guided on and/or through the bipolar plates in the case of an electrolyzer, an electrochemical compressor or a redox flow battery may differ in each case from the media used for a fuel cell system.

The z-axis 7, together with an x-axis 8 and a y-axis 9, spans a right-handed Cartesian coordinate system. The bipolar plates 2 each define a plate plane, in which the separator plates that form the bipolar plates make contact with each other. The separator plates also form their own plate plane in the non-deformed regions thereof, wherein the plate planes of both the bipolar plates and the separator plates are each oriented parallel to the x-y plane and thus perpendicular to the stacking direction or to the z-axis 7. The end plate 4 has a plurality of media ports 5, via which media can be fed to the system 1 and via which media can be discharged from the system 1. Said media that can be fed to the system 1 and discharged from the system 1 may comprise for example fuels such as molecular hydrogen or methanol, reaction gases such as air or oxygen, reaction products such as water vapor or depleted fuels, or coolants such as water and/or glycol.

FIG. 2 shows, in a perspective view, two adjacent bipolar plates 2, known from the prior art, of an electrochemical system of the same type as the system 1 from FIG. 1, as well as a membrane electrode assembly (MEA) 10, known from the prior art, which is arranged between these adjacent bipolar plates 2, the MEA 10 in FIG. 2 being largely obscured by the bipolar plate 2 facing towards the viewer. The bipolar plate 2 is formed from two integrally bonded separator plates 2a, 2b, of which only the first separator plate 2a facing the viewer is visible in FIG. 2, said first separator plate concealing the second separator plate 2b. The separator plates 2a, 2b can each be produced from a metal sheet, e.g. from a stainless-steel sheet or a titanium sheet. The separator plates 2a, 2b can be integrally interconnected, for example welded, soldered or bonded, may be connected by laser welds.

The separator plates 2a, 2b have aligned through-openings, which form through-openings 11a-c of the bipolar plate 2. When a plurality of bipolar plates of the type of the bipolar plate 2 are stacked, the through-openings 11a-c form conduits which extend through the stack 6 in the stacking direction 7 (see FIG. 1). Typically, each of the lines formed by the through-openings 11a-c is fluidically connected to one of the ports 5 in the end plate 4 of the system 1. For example, coolant can be introduced into the stack or discharged from the stack via the lines formed by the through-openings 11a. In contrast, the lines formed by the through-openings 11b, 11c may be configured to supply fuel and reaction gas to the electrochemical cells of the fuel cell stack 6 of the system 1 and to conduct the reaction products out of the stack. The media-conducting through-openings 11a-11c are each oriented substantially in parallel with the plate plane. The through-openings, which are flush with each other, of the successive bipolar plates of a stack together form a conduit in the direction substantially perpendicularly to the plate plane.

To seal off the through-openings 11a-c from the interior of the stack 6 and from the surroundings, the first separator plates 2a each have sealing arrangements in the shape of sealing beads 12a-c, which in each case are arranged around the through-openings 11a-c and completely encompass the through-openings 11a-c in each case. On the rear side of the bipolar plates 2, facing away from the viewer of FIG. 2, the second separator plates 2b have corresponding sealing beads for sealing off the through-openings 11a-c (not shown).

In an electrochemically active region 18, the first separator plates 2a have, on the front side thereof facing towards the viewer of FIG. 2, a flow field 17 with structures 16 for guiding a reaction medium along the front side of the separator plate 2a. In FIG. 2, these structures are provided by a multiplicity of ridges and by channels that extend between the ridges and are delimited by the ridges. On the front of the bipolar plates 2 facing the viewer of FIG. 2, the first separator plates 2a additionally each have at least one distribution or collection region 20, the structures of which distribute a medium from a through-opening 11b to the active region 18 and/or pool it from the active region 18 and convey it to one of the through-openings 11b. In FIG. 2, the distribution structures of the distribution or collection region 20 are likewise provided by ridges and by channels that extend between the ridges and are delimited by the ridges.

The sealing beads 12a-12c have passages 13a-13c, which allow e.g. coolant to pass between the through-opening 11a and the distribution region 20 such that the coolant reaches the distribution region between the separator plates and is carried away out of it. In addition, the passages 13b allow hydrogen to pass between the through-opening 11b and the distribution region on the upper face of the top separator plate 2a. The passages 13c allow e.g. air to pass between the through-opening 11c and the distribution region 20 such that air reaches the distribution region on the underside of the lower separator plate 2b and is carried away out of it. The passages 13a-13c can be formed as elevated portions or perforations of the beads themselves or be formed as perforations of stamped structures that extend out of the beads.

The first separator plates 2a each further have an additional sealing arrangement in the form of a peripheral bead 12d, which wraps around the flow field 17 of the active region 18, the distribution or collection region 20 and the through-openings 11b, 11c and seals them from the area surrounding the system 1. As regards the through-opening 11a, the peripheral bead 12d provides spatial separation from the distribution region 20 and allows coolant to pass to the distribution region 20 in the interior of the bipolar plate (or more precisely the cavity 19 therein) via the passage 13a. The second separator plates 2b each comprise corresponding peripheral beads. The structures 16 of the active region 18, the distribution structures of the distribution or collection region 20 and the sealing beads 12a-d are each formed in one piece with the separator plates 2a, 2b and are molded into the separator plates 2a, 2b, e.g. in a stamping, deep-drawing or hydro forming process.

The separator plates 2a, 2b of the bipolar plate 2 can, for example, each be formed from a stainless-steel sheet having a thickness of less than 100 mm. The bipolar plate 2 usually has a substantially rectangular shape.

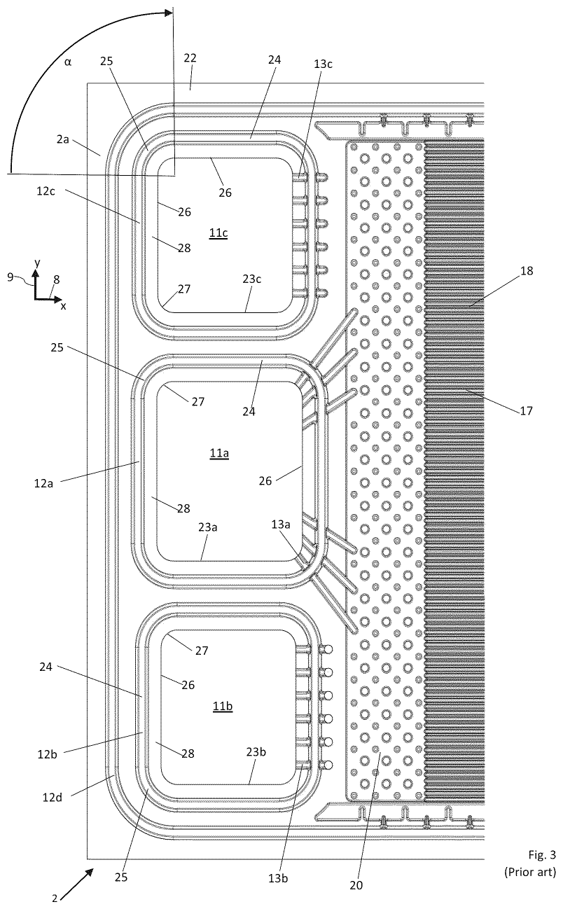

FIG. 3 is a plan view of a segment of a further bipolar plate 2 according to the prior art. The bipolar plate 2 according to FIG. 3 is composed of precisely two metal separator plates 2a, 2b, like the bipolar plate 2 according to FIG. 2, the separator plate 2b being concealed by the separator plate 2a facing the viewer of FIG. 3.

The bipolar plate 2 likewise has through-openings 11a-c for conducting media through the bipolar plate 2. In each case, the through-openings 11a-c are in fluid communication with one another at opposite sides or ends of the bipolar plate 2. A sealing bead 12a, 12b, 12c wraps around each of the through-openings 11a-c and is configured for sealing the through-openings 11a-c. The sealing beads 12a-c are sometimes referred to as port seals. In addition, the separator plate 2a of the bipolar plate 2 has a perimeter bead 12d. Unlike the peripheral bead 12d of the bipolar plate 2 according to FIG. 2, the peripheral bead 12d of the bipolar plate 2 according to FIG. 3 wraps around not only the active region 18, the distribution or collection regions 20 and the through-openings 11b and 11c, but also around the through-openings 11a; it therefore encompasses all the through-openings 11a-12c.

Similarly to FIG. 2, in the separator plate 2a of the bipolar plate 2 of FIG. 3, the second through-openings (denoted by 11a) are in fluid communication with one another via passages 13a through the sealing beads 12a and via a cavity 19 (not visible in the plan view) enclosed by the separator plates 2a, 2b of the bipolar plate 2. The through-openings of the separator plate 2a of the bipolar plate 2, which are denoted by 11c, are in fluid communication with one another via passages 13c through the sealing beads 12c and via distribution and collection regions 20, which in this case have knob-like structures rather than linear structures, and via an active region 18 of the separator plate 2b (which is concealed in FIG. 3). Like in FIG. 2, the edges of the distribution or collection regions 20 extend in parallel with the side borders of the bipolar plate 2.

By contrast with FIG. 2, the through-openings 11a-c of the bipolar plate 2 or of the separator plates 2a, 2b of the bipolar plate 2 each have a substantially rectangular shape. The through-openings 11a-c are each delimited by a border 23a-c, each border 23a-c having four corner regions 27 having a curved contour and four regions 26 therebetween having a straight contour. An edge portion 28 stretches between the sealing bead 12a-c and the border 23a-c, such that the sealing beads 12a-c are spaced apart from the border 23a-c. The borders 23a-c of the through-openings 11a-c can be oriented in parallel with the side borders of the bipolar plate 2. The through-openings 11a-c are arranged next to one another along the y-direction 9 and thus transversely to the longitudinal direction of the bipolar plate 2 and are oriented symmetrically or substantially symmetrically to one another along the x-direction 8. Due to the rectangular shape of the through-openings 11a-c, a surface area of the bipolar plate 2 or of the separator plates 2a, 2b can be better utilized in comparison to the round through-openings 11a-c of FIG. 2. For example, a surface area used by the outer edge region 22 can thus be reduced or minimized.

Due to the round shape of the through-openings 11a-c associated therewith, the sealing beads 12a-c of the bipolar plate 2 or separator plates 2a, 2b shown in FIG. 2 usually also have a round course. As a result, a compression of the sealing beads 12a-c of the bipolar plates 2 installed in the system 1 is substantially uniform along the direction of extension thereof.

Due to the substantially rectangular through-openings 11a-c of the bipolar plate 2 or of the separator plates 2a, 2b of FIG. 3, the associated sealing beads 12a-c usually also have a substantially rectangular course, which is composed of four sub-portions 24 and four corner regions 25. Due to the curved or bent shape of the course of the sealing beads 12a-c in the corner regions 25 thereof, the sealing beads 12a-c typically have a greater stiffness there than in the sub-portions 24 thereof, which often have a rectilinear course. The sealing beads 12a-c thus have a varying degree of compression or springback along their course, such as in the installed state of the bipolar plate 2, that is to say, for example, in the stack 1.

Owing to the large number of bipolar plates 2 or individual plates 2a, 2b in the stack 1, a slight difference in the compression and resilience of each sealing bead 12a-c along the contour thereof in just one bipolar plate 2 or in just one metal separator plate 2a, 2b can lead to a relatively large difference in the resilience of the serially connected sealing beads 12a-c, and so minor differences in the individual separator plates 2a, 2b can have a significant impact on the tightness of the stack 1 as a whole.

Embodiments of the present disclosure help to utilize the surface area of the bipolar plate 2 or of the separator plates 2a, 2b as efficiently as possible, and to ensure tightness in the region of the through-openings 11a-c.

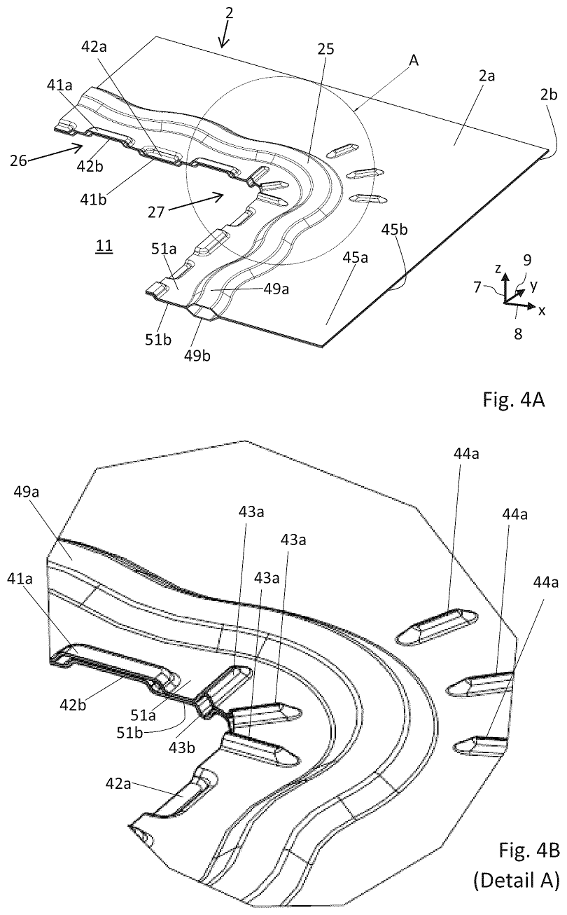

To bring about a more homogeneous compression force on the bead arrangement 12a-c, alternating projections 41a, 42a and recesses 41b, 42b and/or strain-relief beads 43a, 43b, 44a, 44b (explained in more detail below) are provided in the separator plates 2a, 2b (see FIG. 4-11).

Specifically, an edge portion 51a, 51b stretches between a bead arrangement 49a, 49b and a border of the through-opening 11. The edge portion 51a, 51b comprises recesses 42a, 42b and projections 41a, 41b starting from the border and alternating successively in some portions along a border contour. The recesses 42a, 42b project out of the relevant plate plane 45a, 45b in the opposite direction to the bead arrangements 49a, 49b, and the projections 41a, 41b project out of the relevant plate plane 45a, 45b in the same direction as the bead arrangements 49a, 49b (cf. for example FIG. 4-8). In this context, in the view in FIG. 4, the recess 42a and the projection 41b project downwards and the recess 42b and the projection 41a project upwards out of their respective plate plane 45a, 45b. Alternatively or additionally, a strain-relief bead 43a, 43b adjoins the curved portion 27 of the border (cf. FIGS. 4, 5, 7, 9, 10 and 11) or is arranged outside an edge portion 51a, 51b stretching between the bead arrangement 49a, 49b and the curved portion of the border 27 such that the bead arrangement 49a, 49b extends between the strain-relief bead 44a, 44b and the curved edge portion 27 (cf. FIGS. 4, 5 and 8-11).

Further details will be set out below.

FIG. 4 shows a segment of a first embodiment of a bipolar plate in two schematic illustrations (FIG. 4A and FIG. 4B). A coordinate system 7, 8, 9 is also shown and applies to both illustrations.

FIG. 4A is a perspective view of a corner region 27 of a through-opening 11 of a bipolar plate 2 whereas FIG. 4B is a detailed view of FIG. 4A. The bipolar plate 2 shown has two interconnected separator plates 2a, 2b. The two separator plates 2a, 2b have, adjoining the corner region 27, two straight border portions 26 which are arranged at an angle to one another and merge into one another or are interconnected in the corner region 27 by means of a curved portion. In this case, “straight” means that the border portions have substantially no curvature when projected onto the plate plane.

The first separator plate 2a has a bead arrangement 49a and projections 41a, which project upwards out of a plate plane 45a. In this case, the plate plane 45a is parallel to a plane spanned by the x-direction 8 and the y-direction 9 of the coordinate system shown. In this case, the bead arrangement 49a and the projections 41a project out of the plate plane 45a in the positive z-direction 7. The first separator plate 2a likewise has recesses 42a, which project downwards out of the plate plane, e.g. in the negative z-direction 7. The projections 41a and recesses 42a start from the straight border portions 26. The projections 41a and recesses 42a alternate with one another along the border contour. Each straight border portion can have at least two recesses and at least two projections.

A second plate plane 45b of the second separator plate 2b is oriented in parallel with the first plate plane 45a. The separator plate 2b likewise has a bead arrangement 49b, a plurality of projections 41b and a plurality of recesses 42b. The second separator plate 2b is arranged such that the bead arrangement 49b and the projections 41b project out of the plate plane 45b in the negative z-direction 7. The recesses 42b of the second separator plate 2b project out of the plate plane 45b in the positive z-direction 8, e.g. in the opposite direction to the bead arrangement 49b.

The bead arrangements 49a, 49b can represent one of the above-described bead arrangements 12a, 12b or 12c or be formed by one of those bead arrangements 12a-c. Also shown is the through-opening 11, which can correspond to one of the through-openings 11a-c.

The projections 41a, 41b, recesses 42a, 42b and strain-relief beads 43a, 43b are formed as stampings, each extending in a distinct region of the border. The projections 41a, 41b, recesses 42a, 42b and strain-relief beads 43a, 43b form structures that project out of the plate plane and do not form a closed volume with the plate plane. On the other hand, the strain-relief beads 44a, 44b form structures that project out of the plate plane and, in the process, form a closed volume together with the plate plane. FIG. 4B shows that, in the region of the projection 41a and recess 42b, the border projects out of the plate planes 45a and 45b, respectively. The projections 41a, 41b and recesses 42a, 42b are usually arranged at a distance from the bead arrangement 49a, 49b, it being possible for there to be a minimum distance of at least 0.2 mm and at most 2.5 mm between the bead arrangement 49a, 49b and the projections 41a, 41b or recesses 42a, 42b. In addition, the projections 41a, 41b and recesses 42a, 42b generally each have planar surfaces oriented in parallel with the plate plane 45a, 45b, referred to as projection tops and recess bases, respectively.

In the embodiment shown in FIG. 4A, the shapes of each projection 41a, 41b are the same in terms of both outline and height profile, regardless of whether they belong to the first or second separator plate. The same applies to the recesses 42a, 42b, the shapes of which are likewise identical regardless of whether they are arranged on the first or second separator plate. Embodiments are conceivable in which, for example, all the projections of a first separator plate each have the same shape, but the recesses of the other separator plate are shaped differently from the projections of the first separator plate, such as those in which the recesses of the second separator plate are slightly smaller than the projections of the first separator plate, e.g. take up less surface area in plan view.

Each separator plate 2a, 2b can additionally have a plurality of inner strain-relief beads 43a, 43b and a plurality of outer strain-relief beads 44a, 44b. The strain-relief beads 43a, 43b, 44a, 44b can be arcuate in a cross section transverse to their longitudinal direction and can thus be flexible in the x-y plane so that stresses can be prevented from building up in the material of the separator plate and the strain in the bead arrangement 49a, 49b can be relieved. The outline of the inner and outer strain-relief beads 43a, 43b, 44a, 44b can, for example, be a rectangle having rounded corners (on two sides in the case of inner strain-relief beads; on all sides in the case of outer strain-relief sides) when projected onto the plate plane. In this case, a length of the rectangle may correspond to at least 4 times, 3 times, 2 times or 1.5 times the width of the rectangle. The radius of the rounded corners may, for example, correspond to half the width of the rectangle. Depending on the approach, the region of the rounded corners may or may not be taken into account when determining the length.

In this case, the inner strain-relief beads 43a, 43b are arranged in an edge region 51a, 51b of the separator plates 2a, 2b, said edge region being spanned by the bead arrangement 49a, 49b and the border of the through-opening 11, or more precisely adjoining the corner region 27 of the border. The inner strain-relief beads 43a, 43b are formed as stampings, which each extend in a distinct region of the border. FIG. 4B shows that, in the region of the strain-relief beads 43a, 43b, the border projects out of the relevant plate plane 45a, 45b. In the example shown, the number of inner strain-relief beads 43a, 43b is identical to the number of outer strain-relief beads. Embodiments in which the number of inner strain-relief beads differs from the number of outer strain-relief beads are entirely conceivable.

The outer strain-relief beads 44a, 44b are arranged and oriented such that a straight line extending in the longitudinal direction of the outer strain-relief bead 44a, 44b intersects the border of the through-opening 11 substantially perpendicularly. In this case, the inner strain-relief beads 43a, 43b are also arranged or oriented such that a straight line extending in the longitudinal direction thereof intersects the border substantially perpendicularly.

The two separator plates 2a, 2b are formed and arranged such that the recesses 42a, 42b of one separator plate 2a, 2b engage in the projections 43a, 43b of the other separator plate 2a, 2b. Embodiments are possible in which the recesses of one separator plate are in contact with the projections of the other separator plate at least in some portions, for example in the region of the bases or tops thereof.

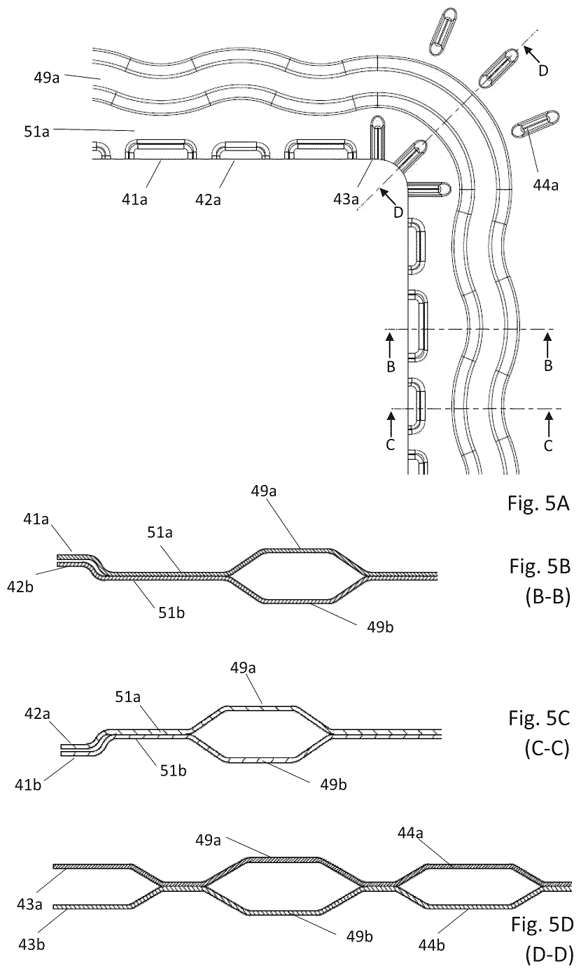

FIG. 5, including sub-figures FIG. 5A-5D, is a plan view of a bipolar plate 2 plus a number of sectional views. FIG. 5 shows the edge portion 51a, 51b stretching between the bead arrangement and the border. In the plan view of FIG. 5A, a wave-like contour of the bead arrangement 49a along the edge portions can be seen. The contour of the bead arrangement 49b of the separator plate 2b (which is concealed and not visible in this figure) is identical to and congruent with the contour of the bead arrangement of the visible plate 2a. The wave-like contour of the bead arrangement 49a, 49b leads to convex and concave edge portions, which adjoin concave and convex portions of the bead arrangements, respectively. Therefore, concave and convex edge portions alternate along the wave-like contour of the bead arrangement 49a, 49b. In the embodiment of the separator plates 2a, 2b shown in FIG. 5, a projection 41a, 41b or a recess 42a, 42b is assigned to each convex and each concave edge portion, at least in the portion shown. In this embodiment, the projections 41a, 41b and recesses 42a, 42b are arranged on the points of the border at which the bead arrangement contour is at the shortest or greatest distance from the border.

FIG. 5B is a sectional view on the sectional plane highlighted by the section line B-B. In this case, the sectional plane is arranged perpendicularly to the plate planes 45a, 45b and perpendicularly to the border. It intersects a projection 41a of the separator plate 2a and a recess 42b of the separator plate 2b and the bead arrangements 49a, 49b. The bead arrangements 49a, 49b are cut through in a region in which their contour is at the greatest distance from the border. A recess 42b of the second separator plate 2b engages in the projection 41a of the first separator plate 2a.

FIG. 5C is a sectional view on the sectional plane highlighted by the section line C-C. In this case, the sectional plane is arranged perpendicularly to the plate planes 45a, 45b and perpendicularly to the border. It intersects a recess 42a of the separator plate 2a and a projection 41b of the separator plate 2b and the bead arrangements 49a, 49b. The bead arrangements 49a, 49b are cut through in a region in which their contour is at the shortest distance from the border. The recess 42a of the first separator plate 2a engages in the projection 41b of the second separator plate 2b.

FIG. 5D is a sectional view on the sectional plane highlighted by the section line D-D. In this case, the sectional plane is arranged perpendicularly to the plate planes 45a, 45b and perpendicularly to the border. It intersects, inter alia, inner strain-relief beads 43a, 43b of the separator plates 2a, 2b, the bead arrangements 49a, 49b and outer strain-relief beads 44a, 44b. This sectional view 5D shows that the strain-relief beads 43a, 43b, 44a, 44b can be arranged such that each strain-relief bead 43a, 44a of one separator plate 2a can be opposite a strain-relief bead 43b, 44b on the second separator plate 2b. The opposing strain-relief beads 43a, 43b and 44a, 44b of the two separator plates 2a, 2b, respectively, can be arranged in parallel with one another and can overlap one another at least in some regions, usually in their entirety. By contrast with the example shown in FIG. 5, for instance the length of the strain-relief beads 43a, 43b and 44a, 44b arranged one above the other can differ.

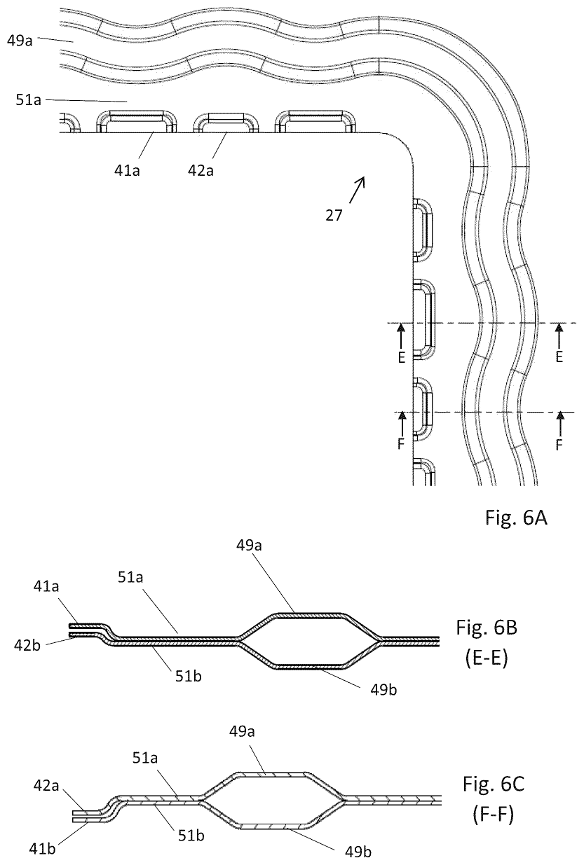

FIG. 6, including sub-figures FIG. 6A-6C, shows a further embodiment. This embodiment is similar to the embodiment shown in FIGS. 4 and 5 but does not have any strain-relief beads. In the corner region 27 of the through-opening 11, the curved edge portion 51a between the border and the bead arrangement 49a is thus formed as a planar surface without any stamped structures or beads. FIG. 6A is a schematic plan view of this embodiment. FIG. 6B and 6C are sectional views on the sectional planes highlighted by the section lines E-E and F-F, respectively. The sectional views show that, in this case, the recesses 42a, 42b of FIG. 6B are stamped to a lesser extent than the projections 41a, 41b, thereby producing a gap of at most 100 mm between meshing recesses 42a, 42b and projections 41a, 41b.

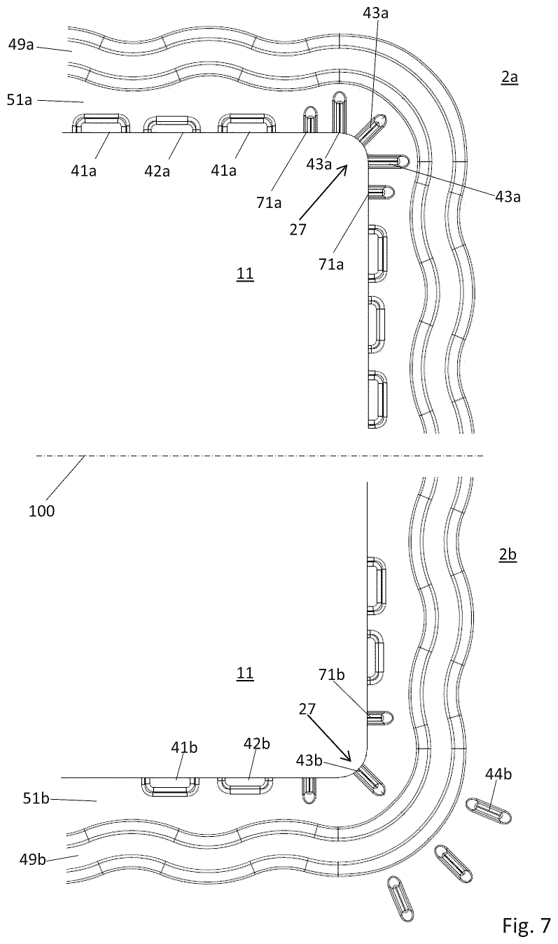

FIG. 7 shows a further embodiment of the bipolar plate 2, in each case showing a plan view of segments of the two separator plates 2a, 2b, which come to rest one on top of the other in the bipolar plate and which, upon rotation about the axis 100, can be moved such that they come to rest on top of one another. In this embodiment example, the two separator plates have different configurations in terms of the strain-relief beads 43a, 43b, 44a, 44b, projections 41a, 41b and recesses 42a, 42b. Whereas the separator plate 2a has three inner strain-relief beads 43a in the curved portions of the border and also, on either side thereof, a further strain-relief bead 71a in the straight regions of the border, the separator plate 2b only has one inner strain-relief bead 43b plus two further strain-relief beads 71b, which, in the finished bipolar plate 2, each overlap one of the strain-relief beads 43a, 71a of the first separator plate 2a. The further strain-relief beads 71a are structurally similar to the inner strain-relief beads 43a, 43b but have a shorter length. For details, therefore, reference is made to the description of the inner strain-relief beads 43a, 43b. They can serve to relieve the strain on the bead arrangement 49a, 49b between the curved portion and a projection and/or recess. By contrast with the first separator plate 2a, the second separator plate 2b additionally has three outer strain-relief beads 44b. FIG. 7 is a schematic plan view of two separator plates 2a, 2b of this embodiment.

In this embodiment, the projections and recesses in both separator plates 2a, 2b are arranged opposite inflection points of the wave-like contour of the bead arrangement 49a, 49b. These inflection points of the contour of the bead arrangement are the points at which the contour of the bead arrangement 49a, 49b changes its curvature behavior, e.g. transitions from concave to convex and vice versa. The recesses 42a, 42b are each slightly smaller than the projections 41a, 41b such that the recesses 42a, 42b are received in the projections 41a, 41b. A recess corresponding to the furthest projection 41a away from the corner region 27 in the separator plate 2a is not formed in the separator plate 2b.

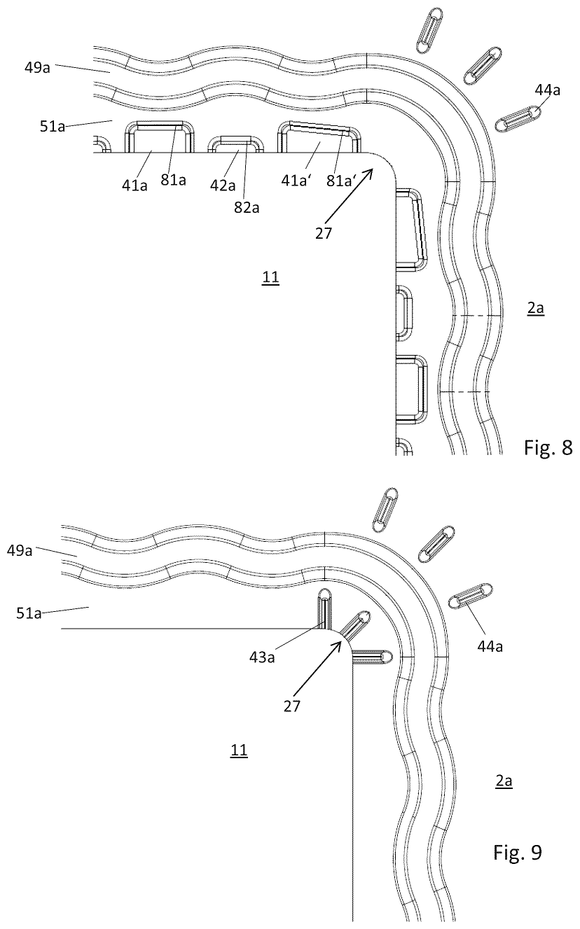

FIG. 8 is a schematic plan view of a further embodiment. This embodiment has outer strain-relief beads 44a, 44b (not visible) but no inner strain-relief beads. Independently of this, the outline varies from projection 41a to projection 41a′. Whereas at least one portion, arranged opposite the border, of the outline of a projection 41a extends in parallel with the edge, like the recess 42a, for instance the flection borders 81a, 82a, the projection 41a′ does not have any such portion of the outline arranged opposite the border and extending in parallel with the border; instead, the flection border 81a′ facing the bead arrangement 49a extends obliquely to the border. Variants in which merely the width and/or the length of the projection 41a, 41a′ varies but, for example, portions parallel to the border are maintained, are also conceivable. Embodiments in which the outline of the recesses 42a can additionally or alternatively be varied are also conceivable. Furthermore, it is conceivable for the separator plate 2a, in a variant of the outlines of projections 41a, 41a′ and/or recesses 42a, to not have any strain-relief beads, to have only inner strain-relief beads 43a, 43b and/or to have inner 43a, 43b, outer 44a, 44b and/or further strain-relief beads 71a. Optionally or alternatively, it is conceivable that the depth and/or the height of the recesses 42a or projections 41a, 41a′ also vary.

FIG. 9 shows an embodiment without any projections and recesses, in which the separator plate 2a merely has inner and outer strain-relief beads 43a, 44a. Embodiments in which further strain-relief beads may be provided in the straight portion as well are also conceivable.

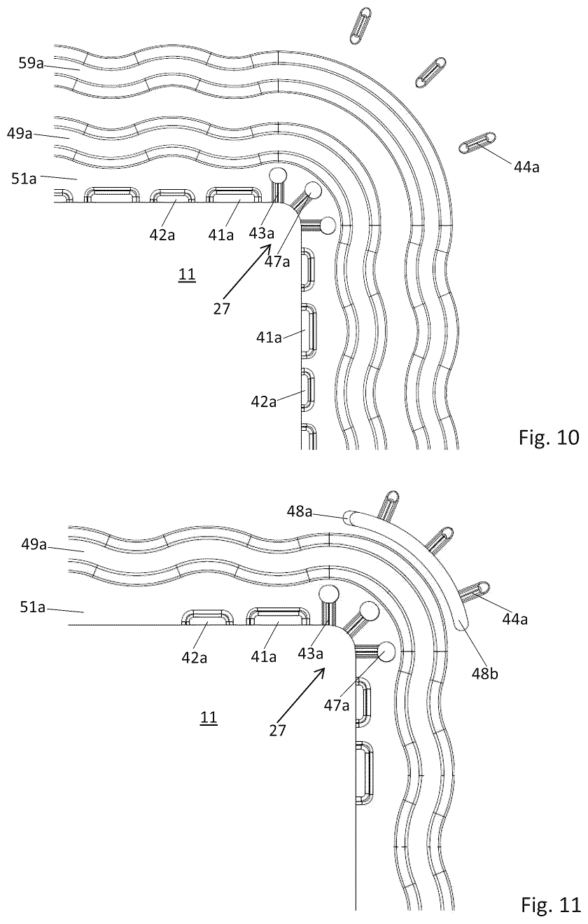

FIG. 10 shows an embodiment in which the outer strain-relief beads are arranged such that two bead arrangements 49a, 59a are arranged between the outer strain-relief beads 44a and the border of the through-opening 11. By way of example, the two bead arrangements can correspond, on the one hand, to a peripheral bead 59a similar to the peripheral bead 12d in FIGS. 2 and 3 and, on the other hand, to a port bead 49a similar to the port bead 12a, 12b or 12c in FIGS. 2 and 3. Whereas the port bead 49a entirely surrounds the through-opening 11, the peripheral bead 59a differs from both the port bead 49a and the through-opening 11 in terms of its further contour. In addition, this embodiment differs from the previous ones in that the inner strain-relief beads 43a, 43b have additional openings 47a on their ends facing the bead arrangements 49a, 59a, which allow for a further reduction, or further prevention, of stresses in the direction perpendicular to the border of the through-opening.

FIG. 11 shows an embodiment in which, like in FIG. 10, openings 47a are formed on the end of the inner strain-relief beads 43a, 43b that faces the bead arrangement 49a. Furthermore, crescent-shaped openings 48a, 48b are made in the two separator plates 2a, 2b at the end of the outer strain-relief beads 44a, 44b that faces the bead arrangement 49a, said openings extending along the inner ends of the outer strain-relief beads 44a, 44b. Instead of the individual openings 47a, a similar crescent-shaped cut-out could also be provided at the outer end of the inner strain-relief beads. Likewise, individual openings 47a could be provided at the inner end of the outer strain-relief beads 44a, 44b. In the embodiment of FIG. 11, only recesses 42a and projections 41a are provided in a region of the straight portion 26 immediately adjoining the corner region 27 of the border. Alternatively, the projections 41a and recesses 42a can also be provided along the entire straight portion 26 (cf. for example FIGS. 4-6, 8 and 10).

In the embodiments of both FIG. 10 and FIG. 11, the additional openings 47a, 48a, 48b are connected only to the strain-relief beads 43a, 43b, 44a, 44b and are spaced apart from the bead arrangements 49a, 49b, 59a, 59b.

It should also be noted that the projections 41a, 41b, recesses 42a, 42b, strain-relief beads 43a, 43b, 44a, 44b and bead arrangements 49a, 49b are each formed in one piece with the separator plates 2a, 2b and are molded into the separator plates 2a, 2b, for example in a stamping, deep-drawing or hydroforming process.

FIG. 4-11 also show that each bead arrangement 49a, 49b has a bead top, each projection 41a, 41b has a projection top and each recess 42a, 42b has a recess base. Generally, the bead top, the projection top and the recess base are each oriented in parallel with the plate plane 45a, 45b and configured as a planar surface. The strain-relief beads 43a, 43b, 44a, 44b, 71a generally have domed, relatively flexible bead tops so that material stresses in the x-y plane can be compensated for.

The separator plates 2a, 2b in FIG. 4-11 are joined together and form a bipolar plate 2. In this case, the through-openings 11 are arranged in alignment with one another or so as to partly overlap. In addition, the bead arrangements 49a, 49b, 59a, 59b of the separator plates 2a, 2b point away from one another. Further details of the bipolar plate 2 can be taken from the above description. By way of example, the separator plates 2a, 2b can be interconnected in their edge portions 51a, 51b by means of at least one weld, such as a laser weld. In principle, this is possible anywhere in the regions where the edge portion 51a of the first separator plate 2a is in contact with the edge portion 51b of the second separator plate 2b. It can therefore also be done where the projections and recesses of the two separator plates 2a, 2b contact one another.

In addition, an electrochemical cell is proposed, comprising two of the above-described separator plates 2a, 2b. The electrochemical cell additionally has a membrane electrode assembly arranged between the separator plates 2a, 2b, such as the MEA 10 of the type described above in the context of FIG. 2. The through-openings 11 are arranged in alignment with one another or so as to partly overlap. In addition, in this approach, the bead arrangements 49a, 49b, 59a, 59b of the separator plates 2a, 2b of the adjacent bipolar plates face one another. It may be provided that the projections 41a, 41b and/or the at least one strain-relief bead 43a, 43b of the separator plates 2a, 2b form support surfaces for the MEA 10.

FIGS. 1-11 are shown approximately to scale. FIGS. 1-11 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, comprising at least one through-opening, having a border that delimits the through-opening, for the passage of a fluid; and
at least one bead arrangement, which extends around the through-opening at a distance from the border at least in some portions and projects upwards out of a plate plane defined by the separator plate,
wherein an edge portion stretches between the at least one bead arrangement and the border, and the edge portion has recesses and projections starting from the border and alternating successively along a border contour in some portions, wherein the recesses project downwards out of the plate plane and the projections project upwards out of the plate plane.

2. The separator plate according to claim 1, wherein the projections and the recesses are arranged at a distance from the closest bead arrangement to the border.

3. The separator plate according to claim 1, wherein the border is substantially straight along its contour between the projections and recesses and/or the border is straight at least in some portions along its contour in the region of the projections and/or recesses.

4. The separator plate according to claim 1, wherein the projections and recesses are formed having different lengths along the border and/or are formed having different widths perpendicularly to the border.

5. The separator plate according to claim 1, wherein the projections and recesses each have, on their side remote from the through-opening, a flection border which, in its longitudinal direction, extends in parallel with the border.

6. The separator plate according to claim 1, wherein the edge portion between the projections and recesses is located in the plate plane at least in some portions and/or is configured as a planar surface.

7. The separator plate according to claim 1, wherein
the at least one bead arrangement has a bead top and/or
at least one projection has a projection top and/or
at least one recess has a recess base,
wherein the bead top, the projection top and/or the recess base is/are each oriented substantially in parallel with the plate plane and/or is/are configured as a planar surface.

8. The separator plate according to claim 1, comprising at least one strain-relief bead, spaced apart from the at least one bead arrangement, for relieving the strain on the at least one bead arrangement when the separator plate is in a compressed state, wherein the border has a curved portion at least in a corner region of the through-opening, and the strain-relief bead adjoins the curved portion of the border, or the strain-relief bead is arranged outside the edge portion such that the at least one bead arrangement extends between the strain-relief bead and the curved portion of the border.

9. A separator plate for an electrochemical system, comprising
at least one through-opening, having a border delimiting the through-opening, for the passage of a fluid, wherein the border has a curved portion at least in a corner region of the through-opening,
at least one bead arrangement, which extends around the through-opening at a distance from the border at least in some portions and projects upwards out of a plate plane defined by the separator plate, and
at least one strain-relief bead, spaced apart from the at least one bead arrangement, for relieving the strain on the at least one bead arrangement when the separator plate is in a compressed state,
wherein the strain-relief bead adjoins the curved portion of the border, or the strain-relief bead is arranged outside an edge portion stretching between the at least one bead arrangement and the curved portion of the border such that the at least one bead arrangement extends between the strain-relief bead and the curved edge portion.

10. The separator plate according to claim 9, wherein the at least one strain-relief bead is arranged such that a straight line extending in a longitudinal direction of the strain-relief bead intersects the curved portion of the border.

11. The separator plate according to claim 9, wherein at least one strain-relief bead has a cut-out at least in one of its end regions, which cut-out connects the edge region to the raised region of the strain-relief bead, wherein the cut-out is spaced apart from the at least one bead arrangement.

12. The separator plate according to claim 9, wherein the at least one bead arrangement, the projections, the recesses and/or the strain-relief bead are stamped into the separator plate.

13. The separator plate according to claim 9, wherein a height of the projections, a depth of the recesses and/or a height of the strain-relief bead, measured vertically from the plate plane, is/are different and/or is/are less than a height of the at least one bead arrangement.

14. A bipolar plate comprising two interconnected separator plates, each according to claim 1, wherein the separator plates are formed such that:
the through-openings are arranged in alignment with one another or so as to partly overlap, and
the bead arrangements of the separator plates point away from one another.

15. The bipolar plate according to claim 14, wherein the recesses of one separator plate are in contact with the projections of the other separator plate at least in some portions and/or the recesses of one separator plate engage in the projections of the other separator plate.

16. The bipolar plate according to claim 14, wherein the edge portion of one separator plate is in contact with the edge portion of the other separator plate at least in some portions.

17. The bipolar plate according to claim 16, wherein the edge portions of the two separator plates are interconnected by means of at least one weld.

18. A bipolar plate comprising two interconnected separator plates, each according to claim 9, wherein the separator plates are formed such that:
the through-openings are arranged in alignment with one another or so as to partly overlap, and
the bead arrangements of the separator plates point away from one another.

19. An electrochemical cell comprising two separator plates according to claim 1 and a membrane electrode assembly arranged between the separator plates, wherein the through-openings are arranged in alignment with one another or so as to partly overlap, and the bead arrangements of the separator plates face one another, wherein the projections and/or the at least one strain-relief bead of the separator plates form support surfaces for the membrane electrode assembly.

20. The electrochemical system comprising a multiplicity of stacked separator plates according to claim 1.
